(19) United States
(12) Patent Application Publication
(10) Pub. No.: US 2022/0325136 A1
(43) Pub. Date: Oct. 13, 2022

(54) SILICONE COATINGS WITH IMPROVED PROPERTIES

(71) Applicant: VIRGINIA COMMONWEALTH UNIVERSITY, Richmond, VA (US)

(72) Inventors: Kenneth J. Wynne, Midlothian, VA (US); Chenyu Wang, Midlothian, VA (US)

(73) Assignee: VIRGINIA COMMONWEALTH UNIVERSITY, Richmond, VA (US)

(21) Appl. No.: 17/639,291

(22) PCT Filed: Aug. 28, 2020
(86) PCT No.: PCT/IB2020/058072

§ 371 Date: Feb. 28, 2022

Related U.S. Application Data
(60) Provisional application No. 62/892,686, filed on Aug. 28, 2019.

(51) Int. Cl. C09D 183/06; C09D 7/62; C08K 3/013

(52) U.S. Cl. CPC C09D 183/06; C09D 7/62; C08K 3/013

(57) ABSTRACT

A composition and uses thereof are provided, comprising a polymerization product of a reactant composition, the reactant composition comprising: (a) vinyldimethylsiloxy-terminated polydimethylsiloxane, as monomer (M^{VI}DM^{VI}); (b) 45-55% poly(methylhydro-co-dimethylsiloxane), α, Ω-trimethylsiloxy terminated, as crosslinker (M^{VI}DM^{VI}); (c) platinum-divinyltetram-CA ethyl-disiloxane complex, as catalyst; (d) 2,4,6,8-tetramethyl-2,4,6,8-tetravinylcyclotetrasiloxane, as inhibitor; and (e) a filler-like resin composition comprising one or more of dimethylvinylated silica, trimethylated silica, and tetra(trimethylsiloxy) silane, as active ingredient, and one or more of xylene, ethylbenzene and toluene (MQ-R resin).

### RELATED APPLICATIONS

This application claims the benefit of U.S. Application No. 62/892,686, filed Aug. 28, 2019, the entire contents of which are hereby incorporated by reference, the same as if set forth at length.

### ACKNOWLEDGMENT OF GOVERNMENT SUPPORT

This invention was made with government support under Grant Number 1608022 awarded by the National Science Foundation (NSF). The government has certain rights in the invention.

### BACKGROUND

Energy savings and safety are among many potential benefits expected for advanced icephobic coatings. For example, keeping wind turbine blades free from ice accumulation is a major concern for wind farm operators in cold climates. Applications with equally demanding requirements include aircraft wings, where thin coatings are required for weight savings. This application is challenging for elastomeric coatings described herein because adhesion of a rigid object (ice) is inversely related to thickness (˜t/2).

Coating development is challenging because anti-icing technologies are needed to prevent or retard formation for several forms of ice.

For icephobic coatings, desirable features include ease of application and cure, good adhesion to substrates and long-term durability and economy. Coatings based on poly(dimethylsiloxane) elastomers have received much attention due to well-known water repellency and ease of application. Combining repellency with micro-scale roughness (superhydrophobicity) has been employed for amplifying icephobic properties. However, frost accumulation is unimpeded by rugosity and high humidity can result in ice formation between asperities which are subject to damage. Another approach to improve icephobicity is coatings containing perfluorinated species but these are bioaccumulative with little chance for translation to applications.

Icephobic coatings with oil addition have heretofore been very promising. Low or even negligible ice adhesion can be achieved by oil adsorption to porous substrates such as aluminum/boehmite. Low levels of oil addition to polyurethanes has been reported to give tough icephobic “slippage” coatings. The same oil addition strategy has been used for silicone coatings to achieve good durability and ice removal shear strength˜14 kPa.

A laboratory method for determining ice adhesion to silicone coatings with a dynamic mechanical analyzer has been previously reported. Using this method, the dependence of ice adhesion on coating thickness was established for platinum cured Sylgard 184 coatings. Over a coating thickness range of 2-600 m ice adhesion strength (Tice, previously Ps) was found to decrease with increased thickness, leveling off at˜270 μm. For elastomeric coatings, thickness is important because thicker coatings facilitate larger displacements that build up interfacial stress.

### BRIEF DESCRIPTION OF THE DRAWINGS

FIG. 1. Depiction of MQ-R resin Pt-PDMS compositions. The circled region depicts MD^{H}DM (1 kDa) linked to four 28 kDa M^{vi}DM^{vi} moieties (f=4).

FIG. 2. Receding contact angles for MQ-R nanocomposites: A, Pt-PDMS(100) and B Pt-PDMS(25).

FIG. 3. Near-surface chain segments for: A. MD^{H}DM, B. After autoxidation/hydrolysis at air interface and C. Near-surface chain B in water.

FIG. 4. AFM images (rₛₚ 0.8,) for Pt-PDMS(100)-30: A, 60×60 μm, z, 100 nm; B, 5×5 m, z=30 nm.

FIG. 5. 2D height images (50×50 μm) for Pt-PDMS(100) coatings;, z=50 nm for all; Rq is less than 2 nm for 0, 5 and 10 wt %, and increases to 4-6 nm for 20 wt % and 30 wt %.

FIG. 6.5×5 μm phase images for; A, Pt-PDMS(100)-10 and B, Pt-PDMS(100)-30; z=30 nm, rₛₚ 0.8,

FIG. 7. Phase image for Pt-PDMS(100)-0 (5×5 μm).

FIG. 8. Stress-strain curves for A, Pt-PDMS(25)-20 and B, Pt-PDMS(100)-20.

FIG. 9. Elastic modulus for A, Pt-PDMS(25) and B, Pt-PDMS(100) compositions.

FIG. 10. Strain-at-break for A, Pt-PDMS(25) and B, Pt-PDMS(100) coatings.

FIG. 11. Dynamic mechanical analysis data for A. Pt-PDMS(25) and B. Pt-PDMS(100) films; initial cooling 5° C. min⁻¹. Vertical dashed lines indicate the −10 and −30° C. test temperatures for ice adhesion.

FIG. 12. DSC for A. Pt-PDMS(25) and B. Pt-PDMS(100); First heating curves after cooling at 5° C. min⁻¹.

FIG. 13. Representative shear stress vs. distance curves for A, Pt-PDMS(25)-20 and B, Pt-PDMS(100)-20 tested, respectively, at −10 and −30° C. These tests are characterized by Mode 1 ice release (see text).

FIG. 14. A, Storage modulus (E′) at−10 and −30° C. for MQ-R resin filled Pt-PDMS(25) and Pt-PDMS(100) (data from Table 3); B, Ice adhesion strength (τ_{ice}, kPa) for MQ-R filled Pt-PDMS. Cure temperatures and test temperatures (-10 or −30° C.) are color coded.

FIG. 15. Depiction of an ice cylinder on a Pt-PDMS(25) surface: A, −10° C.; supercooled water sites (red dots) do not impede ice removal; B, −30° C., ∧represent frozen water sites to which ice is pinned.

FIG. 16. DCA force distance curves for Pt-PDMS coatings. Overall, decreased area for hysteresis loops is evident for 100° C. cure (right) compared to 25° C. cure (left).

FIG. 17. Force distance curves using a flamed glass slide for test water after DCA analysis: top, cure at 25° C.; bottom 100° C. cure.

FIG. 18. DSC data for Pt-PDMS(25) and Pt-PDMS(100).

FIG. 19. AFM images for Pt-PDMS(25)-30: A, 60×60 μm, rₛₚ 0.8, Rq 7 nm and B, 5×5 m.

FIG. 20. Stress vs strain for Pt-PDMS(25) and Pt-PDMS(100) composites.

FIG. 21. Toughness (area under the stress strain curve) for Pt-PDMS coatings with cured at 25 or 100° C.

FIG. 22. Removal force vs. distance for Pt-PDMS(100)-40 that shows Mode 1 clean fracture at 1.2 mm.

FIG. 23. Removal force vs. distance for Pt-PDMS(25)-30 that shows Mode 2 slippage between 1.3 and 2 mm.

FIG. 24. Removal force vs. distance for Pt-PDMS(100)-0 that shows Mode 3 erratic oscillation between 1.3 and 2 mm.

FIG. 25. Peak force (τ_{ice}) versus (E′)^{1/2} for Pt-PDMS(100) MQ-R compositions.

Data points are marked with wt % MQ-R.

### DESCRIPTION OF THE INVENTION

One embodiment provides a composition, comprising a polymerization product of a reactant composition, the reactant composition comprising:

(a) vinyldimethylsiloxy-terminated polydimethylsiloxane, as monomer (M^{vi}DM^{vi}); (b) 45-55% poly(methylhydro-co-dimethylsiloxane), a, 2-trimethylsiloxy terminated, as crosslinker (MD^{H}DM);

(c) platinum-divinyltetramethyl-disiloxane complex, as catalyst;

(d) 2,4,6,8-tetramethyl-2,4,6,8-tetravinylcyclotetrasiloxane, as inhibitor; and

(e) a filler-like resin composition comprising one or more of dimethylvinylated silica, trimethylated silica, and tetra(trimethylsiloxy)silane, as active ingredient, and one or more of xylene, ethylbenzene and toluene (MQ-R resin).

In one aspect, the vinyldimethylsiloxy-terminated polydimethylsiloxane (M^{vi}DM^{vi}) has a molecular weight of about 28 kDa. In another aspect, the vinyldimethylsiloxy-terminated polydimethylsiloxane (M^{vi}DM^{vi}) is present in an amount of about 40-94 wt. % based on the weight of the reactant composition, which range includes 40, 45, 50, 55, 60, 70, 80, 90, and 94 wt. % or any subrange therein.

In one aspect, the 45-55% poly(methylhydro-co-dimethylsiloxane), a, 2-trimethylsiloxy terminated, has a molecular weight of about 900-1200 Da, which range includes about 900, 950, 1000, 1050, 1100, and 1200 Da or any subrange therein. In another aspect, the 45-55% poly(methylhydro-co-dimethylsiloxane), a, 2-trimethylsiloxy terminated, is present in an amount of about 1-15 wt. % based on the weight of the reactant composition, which range include about 1, 3, 5, 7, 9, 11, 13 and 15 wt. % or any subrange therein.

In one aspect, the platinum-divinyltetramethyl-disiloxane complex is present in an amount of about 0.01 wt. % or less (measured as Pt); from 0.0001 to 0.01 wt. %, from 0.0001 to 0.005 wt. %, or from 0.001 to 0.005 wt. % based on the weight of the reactant composition.

In one aspect, the 2,4,6,8-tetramethyl-2,4,6,8-tetravinylcyclotetrasiloxane is present in amount of about 0.2-1 wt. %, based on the weight of the reactant composition, which range includes about 0.2, 0.4, 0.6, 0.8 and 1 wt. % or any subrange therein.

In one aspect, the active ingredient of the filler-like resin composition (MQ-R resin) is present in an amount of about 5-50 wt. %, based on the weight of the reactant composition, which range includes about 5, 7, 10, 15, 20, 25, 30, 35, 40, 45 and 50 wt. % or any subrange therein.

In one aspect, the reactant composition further comprises hexane as solvent.

In one aspect, the polymerization product is a product of polymerization at a temperature of about 25 to 160° C., which range includes about 25, 30, 35, 40, 50, 60, 70, 90, 100, 120, 140, and 160° C. or any subrange therein.

In one aspect, the composition of has a storage modulus (E′) of about 1-15 MPa at−10° C. In another aspect, the composition has a storage modulus (E′) of about 1-20 MPa at −30° C.

In one aspect, the reactant composition comprises:

(a) 40-94 wt. % vinyldimethylsiloxy-terminated polydimethylsiloxane, as monomer (M^{vi}DM^{vi});

(b) 1-15 wt. % 45-55% poly(methylhydro-co-dimethylsiloxane), α, Ω-trimethylsiloxy terminated, as crosslinker (MD^{H}DM);

(c) 0.001-0.005 wt. % (measured as Pt) platinum-divinyltetramethyl-disiloxane complex, as catalyst;

(d) 0.2-1 wt. % 2,4,6,8-tetramethyl-2,4,6,8-tetravinylcyclotetrasiloxane, as inhibitor;

and

(e) 5-50 wt. % a filler-like resin composition comprising one or more of dimethylvinylated silica, trimethylated silica, and tetra(trimethylsiloxy)silane, as active ingredient, and one or more of xylene, ethylbenzene and toluene (MQ-R resin).

Another embodiment provides a coating, comprising the composition.

In one aspect, the coating has a thickness of about 1-1000 μm, which range includes 1, 5, 20, 50, 100, 250, 500, 700, 1000 μm, or any subrange therein.

In one aspect, the coating has an ice adhesion strength (τ_{ice}) of about 15-40 kPa at−10° C. In another aspect, the coating has an ice adhesion strength (τ_{ice}) of about 20-60 kPa at −30° C.

Another embodiment provides an article, comprising the coating on a surface thereof.

In one aspect, the article may be selected from the group consisting of an airfoil, wing, propeller, hull, superstructure, railing, intake, hatch, keel, rudder, deck, antenna, medical device, kitchen device, counter, pipe, wind turbine, wind turbine blade, aircraft, ship, rotor blade, transmission tower, transmission line, cable, cooling coil, refrigerator, freezer, wire, tape, adhesive tape, wrap, solar panel, window, wall, floor, siding, roofing, shingle, tower, train, train undercarriage, automobile, cowling, cover, evaporator, condenser, radiator, metal, plastic, or combination thereof, comprising any of the coatings or compositions on a surface thereon. In another aspect, one or more intervening layer, primer, adhesive, tape, other coating, or a combination thereof may be present between the coating and the surface of the article.

Another embodiment provides a method, comprising contacting:

(a) vinyldimethylsiloxy-terminated polydimethylsiloxane, as monomer (M^{vi}DM^{vi});

(b) 45-55% poly(methylhydro-co-dimethylsiloxane), α, Ω-trimethylsiloxy terminated, as crosslinker (MD^{H}DM);

(c) platinum-divinyltetramethyl-disiloxane complex, as catalyst;

(d) 2,4,6,8-tetramethyl-2,4,6,8-tetravinylcyclotetrasiloxane, as inhibitor; and

(e) a filler-like resin composition comprising one or more of dimethylvinylated silica, trimethylated silica, and tetra(trimethylsiloxy)silane, as active ingredient, and one or more of xylene, ethylbenzene and toluene (MQ-R resin), to produce a reactant composition;

and polymerizing, to produce a polymerization product.

In one aspect, the polymerizing is carried out at a temperature of about 25 to 160° C., which range includes about 25, 30, 35, 40, 50, 60, 70, 90, 100, 120, 140, and 160° C. or any subrange therein. In another aspect, the method further comprises contacting the reactant composition with a surface, and polymerizing, to produce a coating comprising the polymerization product on said surface.

In one aspect, the coating is ice-phobic. In another aspect, the coating has an ice adhesion strength (τ_{ice}) of <30 kPa at −30° C.

Another embodiment provides a reactant composition, comprising:

(a) vinyldimethylsiloxy-terminated polydimethylsiloxane, as monomer (M^{vi}DM^{vi});

(b) 45-55% poly(methylhydro-co-dimethylsiloxane), α, Ω-trimethylsiloxy terminated, as crosslinker (MD^{H}DM);

(c) platinum-divinyltetramethyl-disiloxane complex, as catalyst;

(d) 2,4,6,8-tetramethyl-2,4,6,8-tetravinylcyclotetrasiloxane, as inhibitor; and

(e) a filler-like resin composition comprising one or more of dimethylvinylated silica, trimethylated silica, and tetra(trimethylsiloxy)silane, as active ingredient, and one or more of xylene, ethylbenzene and toluene (MQ-R resin).

Another embodiment provides a method, comprising contacting:

(a) vinyldimethylsiloxy-terminated polydimethylsiloxane, as monomer (M^{vi}DM^{vi});

(b) 45-55% poly(methylhydro-co-dimethylsiloxane), a, 2-trimethylsiloxy terminated, as crosslinker (MD^{H}DM);

(c) platinum-divinyltetramethyl-disiloxane complex, as catalyst;

(d) 2,4,6,8-tetramethyl-2,4,6,8-tetravinylcyclotetrasiloxane, as inhibitor; and

(e) a filler-like resin composition comprising one or more of dimethylvinylated silica, trimethylated silica, and tetra(trimethylsiloxy)silane, as active ingredient, and one or more of xylene, ethylbenzene and toluene (MQ-R resin).

to produce a reactant composition.

Another embodiment provides a kit, comprising:

a first composition, comprising:

(a) vinyldimethylsiloxy-terminated polydimethylsiloxane, as monomer (M^{vi}DM^{vi});

(c) platinum-divinyltetramethyl-disiloxane complex, as catalyst;

(d) 2,4,6,8-tetramethyl-2,4,6,8-tetravinylcyclotetrasiloxane, as inhibitor; and

(e) a filler-like resin composition comprising one or more of dimethylvinylated silica, trimethylated silica, and tetra(trimethylsiloxy)silane, as active ingredient, and one or more of xylene, ethylbenzene and toluene (MQ-R resin);

and

a second composition, comprising:

(b) 45-55% poly(methylhydro-co-dimethylsiloxane), α, Ω-trimethylsiloxy terminated, as crosslinker (MD^{H}DM).

In one aspect, the first composition further comprises hexane as solvent. In another aspect, the second composition further comprises vinyldimethylsiloxy-terminated polydimethylsiloxane as diluent.

Another embodiment provides a method, comprising contacting the first and second compositions, to produce a reactant composition.

In one aspect, the method further comprises contacting the reactant composition with a surface; and polymerizing, to produce a coating on said surface.

In one aspect, SYL-OFF™ 7210, available from the Dow Chemical Company, is suitable for use as MQ-R resin.

Low adhesion of ice (icephobic) coatings have been previously made by adding silicone oil and other oils to conventional coatings. The Pt-PDMS coatings of the present invention do not use oils to decrease ice adhesion. Nor do these coatings employ fluorinated components that are or degrade to bio-accumulative compounds. Furthermore, the coatings of the present invention are prepared from commercially available starting materials. Finally, the coatings of the present invention do not rely on fragile super-hydrophic wetting behavior that is generated by microfabrication or other expensive methods.

Cure at temperatures above 100° C. are required to generate maximum icephobic properties but other temperature cures, for example ambient temperature cures works well and are also contemplated.

To explore novel coatings with potential for icephobicity, characterization of a series of platinum-cured silicone coatings incorporating SYL-OFF™ 7210, designated MQ-R, was carried out. These optically transparent coatings are designated according to cure temperature and MQ-R wt %, e.g., Pt-PDMS(25)-20 represents 25° C. cure and 20 wt % MQ-R. Surface characterization included dynamic contact angles and morphology by atomic force microscopy. Bulk characterization utilized stress-strain measurements at ambient temperature and dynamic mechanical analysis from −110 to 150° C. Ice adhesion strength was determined by measuring the force, F, to remove ice for a given area A and defining ice adhesion strength as τ_{ice}=F/A. Results show that at −10° C. storage modulus had a dominant effect in increasing τ_{ice}. For −30° C. storage modulus was greater for coatings cured at 100° C. compared to 25° C., but ice removal tests at −30° C. (−22° F.) consistently showed τ_{ice} for Pt-PDMS(100) MQ-R compositions was less than τ_{ice} for Pt-PDMS(25). One possible reason could be that supercooled water at hydrophilic interfacial sites (−10° C.) does not impede ice adhesion but frozen water pins ice at −30° C. As a consequence of a relatively low surface density of frozen interfacial pinning sites, τ_{ice} is less for Pt-PDMS(100) than that for Pt-PDMS(25) analogs at −30° C. despite the higher modulus for Pt-PDMS(100) coatings. Given the criterion that τ_{ice}, <30 kPa at −30° C. constitutes “icephobicity”, Pt-PDMS(25)-5 and Pt-PDMS(100)-5 qualify for the icephobic designation. Interestingly, Pt-PDMS(100)-10 also meets this criterion (τ_{ice}=28 kPa) but Pt-PDMS(25)-10 fails (τ_{ice}=34 kPa). At 20 wt % MQ-R and above, τ_{ice} increases to >30 kPa at −30° C. even for Pt-PDMS(100) compositions. Decreased hydrophilic site density is unable to overcome the effect of increased modulus.

Surprisingly, MQ-R was found to be a reactive filler that increased modulus depending on cure temperature, especially for Pt-PDMS(100)-30 (3 MPa) and Pt-PDMS(100)-40 (5 MPa).

### Examples

In the present investigation, platinum cured PDMS coatings were prepared incorporating SYL7210, which is designated MQ-R for MQ-resin. Ice adhesion strength was determined by measuring the force, F, to remove ice for a given area A and defining ice adhesion strength as τ_{ice}=F/A. An objective was to discern effects of increased modulus associated with increasing weight percent of MQ-R. Secondly, cure was carried out at 25 and 100° C. to confirm effects of water adhesion, namely low temperature cure results in adhesion of water drops (sticky) while cure at −100° C. greatly reduces adhesion of water drops (slippery). The difference can be expressed in terms of work of adhesion and receding contact angles (Eq 1), where wₐ is water drop adhesion and θ_{R} is the receding contact angle.

wₐα(1+cosθ_{R}) Eq 1

Without addition of oil, optically transparent “icephobic” coatings with nanoscale smoothness, good mechanical properties and τ_{ice} less than 30 kPa have now been surprisingly found. For coatings cured at 100° C. the storage modulus was greater compared to cure at 25° C. For ice adhesion at −10° C. increased storage modulus had a dominant effect in increasing τ_{ice}. However, ice removal tests at −30° C. (−22° F.) consistently showed τ_{ice} for Pt-PDMS(100) MQ-R compositions was less than τ_{ice} for the corresponding Pt-PDMS(25). A hypothesis is presented for origins for the opposite trends for τ_{ice} at −10° C. and −30° C.

Experimental

Materials. Vinyldimethylsiloxy-terminated polydimethylsiloxane (M^{vi}DM^{vi}, 28 kDa), poly(methylhydro-co-dimethylsiloxane), α, Ω-trimethylsiloxy terminated (MD^{H}DM, crosslinker, 45-55 mol % D^{H}, MW 900-1200 Da) and platinum-divinyltetramethyl-disiloxane complex, (3.0-3.5 wt. % platinum concentration in another divinyl polydimethylsiloxane as a separate solvent (catalyst)) were purchased from Gelest. In one embodiment, it is contemplated that the divinyl polydimethylsiloxane solvent in the platinum-divinyltetramethyl-disiloxane complex (catalyst) has a molecular weight the same as or similar to that of the vinyldimethylsiloxy-terminated polydimethylsiloxane M^{Vi}DM^{Vi}, 28 kDa, or has a different molecular weight. The 2,4,6,8-tetramethyl-2,4,6,8-tetravinyl-cyclotetrasiloxane (inhibitor) was obtained from Tokyo Chemical Industry Co., Ltd. (TCI). Filler-like SYL-OFF™7210 resin, designated MQ-R was from Dow Corning. According to the MSDS, SYL-OFF™7210 contains xylene, ethylbenzene and toluene. SYL-OFF™7210 resin has 60% active ingredient. Without wishing to be bound, it is believed that this active ingredient includes one or more or all of dimethylvinylated silica, trimethylated silica, dimethylvinylated and trimethylated silica, and tetra(trimethylsiloxy)silane. Compositions reported herein are adjusted to wt % active ingredient or subject ingredient.

Coating Preparation. Platinum-divinyltetramethyl-disiloxane complex (catalyst) and 2,4,6,8-tetramethyl-2,4,6,8-tetravinyl-cylotetrasiloxane (inhibitor) were each diluted in hexane to 10 wt %. The amounts of materials, including M^{Vi}DM^{Vi}, MD^{H}DM crosslinker, inhibitor and catalyst for preparing a series of coatings with increasing MQ-R resin content are shown in Table 1.

TABLE 1
M^{Vi}DM^{Vi}, MQ-R, MD^{H}DM crosslinker,
inhibitor and catalyst components.^{a}

| M^{Vi}DM^{Vi} | MQ-R | MQ-R |
|---|---|---|
| (g) | resin (g) | wt % |
| 15.00 | 0 | 0 |
| 14.25 | 1.25 | 5 |
| 13.50 | 2.50 | 10 |
| 12.00 | 5.00 | 20 |
| 10.50 | 7.50 | 30 |
| 9.00 | 10.00 | 40 |

^{a}Each composition contained 1.5 g MD^{H}DM crosslinker, 0.75 g inhibitor solution (10 wt % in hexane) and 150 μL catalyst solution (10 wt % in hexane).

In a typical coating preparation, M^{vi}DM^{vi}, 0.75 g inhibitor solution (10 wt % in hexane), MQ-R resin and MD^{H}DH crosslinker were placed in a 40 g Flacktek screw-top container. The container was put in a Speed Mixer-DAC 150FV (Flacktek Inc., Landrum SC) followed by high-speed mixing at 2700 rpm for 60 s. This process was repeated 3 times to obtain a homogeneous, bubble-free resin. The resin was cooled in a freezer (−20° C.) for 30 min to slow gelation in the next step. 150 μL catalyst solution (10 wt % in hexane) was added to the resin followed by three high-speed mixing sequences (2700 rpm/60 s). For each resin mixture, 8 dip-coated coverslips and 8 drip-coated microscope slides (1 g material on each slide) were prepared. Dip-coating refers to immersing the coverslips vertically in the resin followed by manipulation to give a reasonably smooth coating. Drip-coating refers to using a pipette to transfer the resin onto one side of a microscope slide and spreading evenly. Plaques were prepared by pouring resin into PTFE plates (1.5-2 g for each plate).

After gelation, one set of coatings was cured in air at ambient temperature for 48 h. A second set of coatings was cured in air at 100° C. by placing coated slides, coverslips and plaques in an oven for 48 h. Coatings are designated Pt-PDMS(25) and Pt-PDMS(100) according to cure temperature. Coatings and plaques were optically transparent and bubble-free.

Dynamic contact angles. Wetting characteristics were determined by dynamic contact angle measurements (DCA, Wilhelmy plate) with a First Ten Angstroms DCA instrument.

Briefly, beakers used for DCA analysis were cleaned by rinsing with distilled water, and treating with a gas/oxygen flame. Water surface tension was checked before each measurement by a contact angle measurement with a flamed glass cover slip.

Deionized water was used as the probe liquid with immersion/withdrawal rates of 100 μms⁻¹. Force-distance curves (fdc's) were obtained and analyzed with instrument software to obtain advancing (θ_{A}) and receding (θ_{R}) contact angles. Three cycles in succession were obtained to study any change in wetting behavior on immersion into water. Reported contact angles are averages of several force-distance cycles. Surface tension of the test water used for analysis was examined with a flamed-glass coverslip to assess whether leaching of contaminants had occurred.

Atomic Force Microscopy. Morphological investigations were carried out with a Bruker Dimension FastScan atomic force microscope (AFM). Tapping-mode imaging was performed in air using microfabricated silicon cantilevers (40 N/m, Veeco, Santa Barbara, Calif.). Tapping force corresponded to set-point ratio rₛₚ of 0.8, where rₛₚ=Aₑₓₚ/Aₒ, Aₒ is free oscillation amplitude and Aₑₓₚ is experimental oscillation amplitude. Scanned images were analyzed and processed using NanoScope Analysis 1.8 software. Height, 3D height and phase images were obtained to assess morphological features and roughness.

Mechanical Testing. Dynamic mechanical analysis (DMA). A TA Instruments RSA-III dynamic mechanical analyzer was used for DMA on samples cut from plaques. Temperature was ramped from −120 to 150° C. at 5° C. min⁻¹. Tension cycles were set at 1 Hz with maximum strain of 0.05%. Maximum autotension was set to 2 mm at a rate of 0.01 mm s⁻¹.

Tensile Testing. Rectangular samples were stamped from cast plaques. After thickness, width, and gauge (mm) measurements, samples were clamped into the holder of a TA Instruments RSA-III. The sample elongation rate was 0.05 mm/s with a data acquisition rate of 1 Hz (24° C.). The modulus was determined from the initial portion of the stress-strain curve.

Differential Scanning Calorimetry. Thermograms were obtained with a TA-Q1000 Series™ Instrument (TA Instruments). Samples (5-10 mg) were equilibrated at −90° C. followed by a heating ramp of 10° C./min to 100° C. A cooling ramp of 10° C./min was applied back to −90° C. and a second heating cycle of 10° C./min to 150° C. was employed. The consecutive heating cycles were followed to observe any changes due to heating.

Ice Adhesion Test. These measurements followed a previous report using a TA Instruments RSA-III and a sample holder for 1 in×1 in coated pieces cut from microscope slides. The force probe was fitted into the upper grip so that it passed 2 mm from the coating surface. Temperature control was achieved with liquid nitrogen boil-off. Tests were conducted at−10 or −30° C. (±0.5° C.).

Coating thickness was fixed at˜270 μm as our previous study showed that peak removal force plateaued at this thickness or greater. Molds to form ice cylinders on coatings were made by cutting 2 cm long pieces from the end (top) of plastic pipettes. The mold was filled with 200 μL of distilled water, placed on the coating and introduced into a freezer at −15° C. for 2-3 h. Ice cylinders were 7.5 mm in diameter (1000 μL pipet) or 5.2 mm in diameter (200 μL pipet).

A coated slide with an adherent ice cylinder was rapidly transferred from the freezer to the precooled chamber and sample holder. After allowing 2 min for thermal equilibration, the force probe was engaged and moved toward the ice cylinder at a selected speed. DMA software was modified to obtain a force vs. distance curves. Removal force is calculated according to Eq 2,

$${τ}_{i c e} = \frac{4 M g}{π {d}^{2}} \qquad Eq 2$$

where τ_{ice} is removal force (kPa), M is the normal force recorded by the load cell (g), g is the gravitational constant (9.8 m/s²), and d is the diameter of ice cylinder (mm).

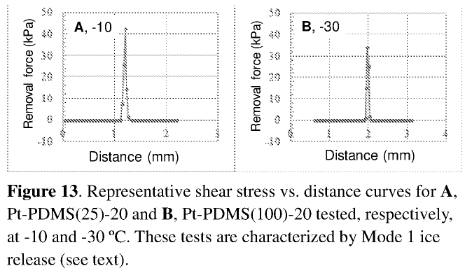

Representative force-distance curves are shown in FIG. 13 for A, Pt-PDMS(25)-20 and B, Pt-PDMS(100)-20. Table 3 lists τ_{ice} for all coatings.

Results

A study was initiated to evaluate SYL-OFF 7210 (MQ-R) as a filler on icephobic behavior and mechanical properties of a model silicone coating. SYL-OFF 7210 and similar compositions have been described as “release” resins for applications such as double sided tapes. From our AFM studies (vida infra) the nature of the “active ingredient” appears similar to treated fumed silica nanoparticles.

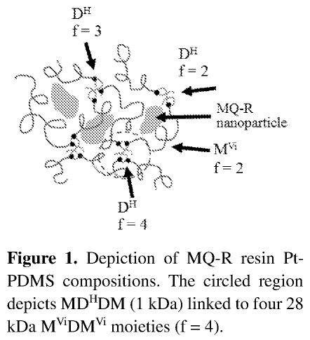

FIG. 1 shows an idealized depiction of an elastomeric coating with MQ-R filler prepared by Pt-cure of divinyl polydimethylsiloxane M^{vi}DM^{vi} (28 kDa). The copolymer crosslinking agent, poly(methylhydro-co-dimethylsiloxane), MD^{H}DM, with a molecular weight of 900-1200 Da contains˜50 mol % —SiHCH₃— designated D^{H}. With a molecular weight of ˜1000 Da, MD^{H}DM has Si—H functionality f_{Si-H} of ˜7.4. Importantly, a mass ratio of 10:1 M^{vi}DM^{vi} to crosslinker MD^{H}DM results in a D^{H} to D^{vi} ratio of ˜10:1, which is similar to Sylgard 184. The depiction in FIG. 1 shows the presence of MQ-R nanoparticles based on AFM imaging.

FIG. 1 depicts MD^{H}DM with a range of functionality resulting from addition of Si—H to M^{vi}MM^{vi}. The architecture produced by hydrosilylation is star-like because of the relatively short MD^{H}DM chains are the nexus for crosslinking M^{Vi}MM^{Vi}. Excess D^{H} results in the formation of a second network at elevated temperatures due to autoxidation of Si—H to Si—OH and condensation to Si—O—Si. This second network accounts for increased modulus with increasing cure temperature. Herein, to explore the impact of secondary network formation on adhesion of ice, platinum cure was carried out at 25 and 100° C. The resulting elastomeric coatings are designated Pt-PDMS(25) and Pt-PDMS(100), respectively.

Designations for specific coatings include the MQ-R wt %, for example, Pt-PDMS(100)-30, where 30 is the MQ-R wt %.

Surface characterization. Dynamic contact angles. Contact angles for Pt-PDMS(25) and Pt-PDMS(100) are listed in Table 2.

TABLE 2
Wilhelmy plate DCA contact angles and CA
hysteresis for MQ-R filled Pt-PDMS(25) and Pt-
PDMS(100).^{a,b}

| MQ-R | Pt-PDMS(25) | | | Pt-PDMS(100) | | |
|---|---|---|---|---|---|---|
| wt % | θ_{A} | θ_{R} | θ_{Δ} | θ_{A} | θ_{R} | θ_{Δ} |
| 0 | 124 | 60 | 64 | 117 | 89 | 28 |
| 5 | 136 | 52 | 84 | 115 | 91 | 24 |
| 10 | 133 | 62 | 71 | 116 | 93 | 23 |
| 20 | 131 | 37 | 94 | 118 | 93 | 25 |
| 30 | 135 | 24 | 111 | 119 | 92 | 27 |
| 40 | 127 | 44 | 83 | 119 | 90 | 29 |

^{a}Contact angle hysteresis = θ_{Δ} = θ_{A} − θ_{R}
^{b}Results are excerpted from Table 5 (Run 1, cycle 1).

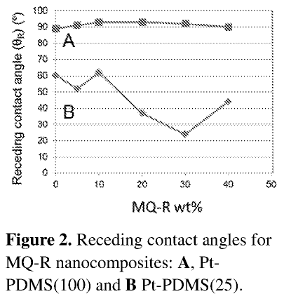

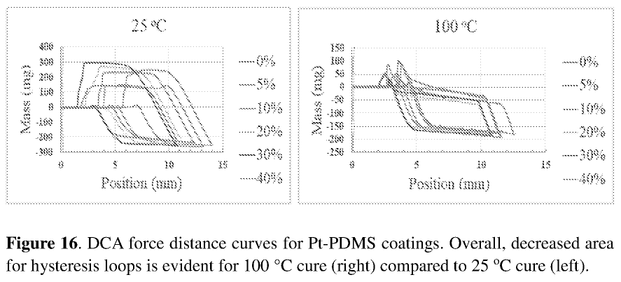

Force distance curves associated with contact angles in Table 2 are shown in FIG. 16. Increased receding contact angles (θ_{R}) result in lower contact angle hysteresis (θ_{Δ}=θ_{A}—θ_{R}) for 100° C. cure which is independent of MQ-R content (FIG. 2). High contact angle hysteresis for low temperature cure confirms previous studies on Pt-cured PDMS coatings cured on a thermal gradient where water drops stuck to the low temperature end but rolled off the high temperature end.

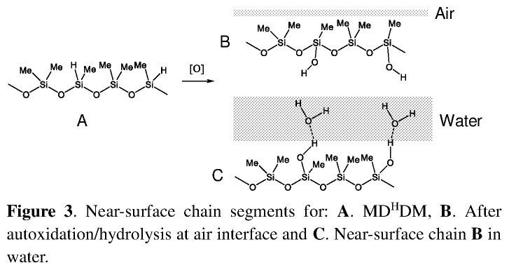

As illustrated in FIG. 3, low temperature cure is accompanied by autoxidation of excess Si—H to near-surface Si—OH. In turn, the presence of polar Si—OH gives rise to pinning water at the receding three phase contact line. Using Eq 1 and receding contact angles in Table 2, the ratio of wₐ for ambient and 100° C. cure can be calculated according to Eq 3. For example, the ratio of wₐ₋₂₅ for Pt-PDMS(25)-20 (θ_{R} 37° ) to that for Pt-PDMS(100)-20 (O_{R}93°) is 1.9. Table 6 lists receding contact angles for all

Wₐ₋₂₅/Wₐ₋₁₀₀ Eq 3

Pt-PDMS coatings and the ratio of the practical work of adhesion for 25 vs 100° C. cure which ranges from 1.5 to 2. The lower receding contact angle for 100° C. cure is important as Mueler, et al., found that ice adhesion (τ_{ice}) followed the practical work of adhesion of water (Eq 1). By comparing icephobicity for cure at 25 and 100° C., trends based on mechanical properties and the presence of interfacial water (low θ_{R}) are described below.

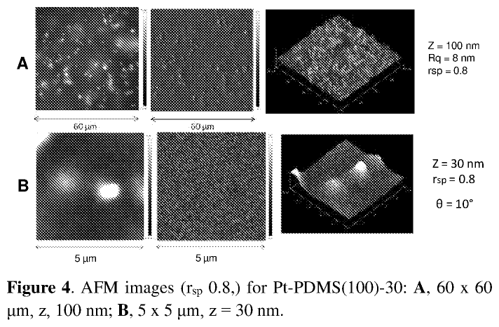

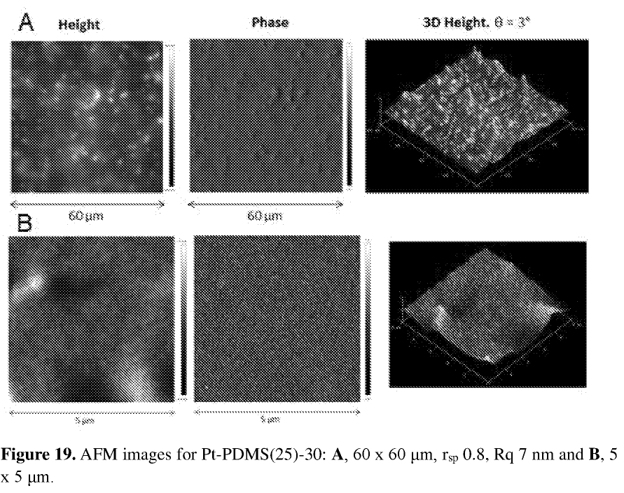

Atomic Force Microscopy. AFM images for Pt-PDMS(100)-30 are shown in FIG. 4. The microstructure is comprised of near surface moieties that amplify Rq to ˜8 nm for the 60×60 m images (FIG. 4A). Images and Rq for 25° C. cure are similar (FIG. 19).

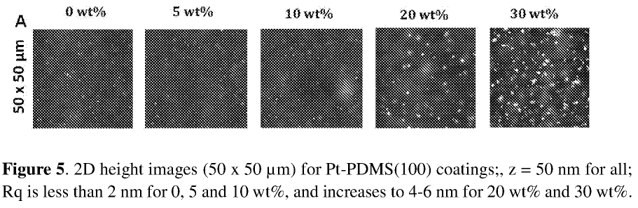

To clarify near surface morphology, height images (50×50 μm) for Pt-PDMS(100) with 0, 5, 10, 20 and 30 wt % MQ-R are shown in FIG. 5. The density of near surface micron scale features increases with MQ-R concentration supporting assignment to an MQ-R component. Rq is less than 2 nm for 0, 5 and 10 wt % but the presence of MQ-R micron scale features increases Rq to 4-6 nm for 20 wt % and 30 wt %.

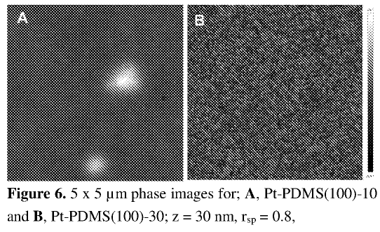

Insight into nanostructure is obtained from 5×5 m phase images for Pt-PDMS(100)-10 and Pt-PDMS(100)-30 shown in FIG. 6. The high density of light colored 30-50 nm features for Pt-PDMS(100)-30 are associated with higher stiffness and are therefore assigned to siliceous nanoparticles. The lower density of nanoscale features for Pt-PDMS(100)-10 is apparent in FIG. 6A giving further support to assignment to siliceous nanoparticles.

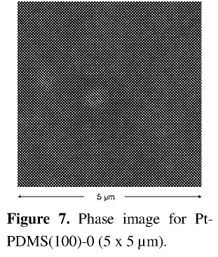

Interestingly, FIG. 7 shows that even without MQ-R, Pt-PDMS(100)-0 has a nanoscale morphology with mesoscale regions (≥100 nm) of higher and lower stiffness. With MD^{H}DM chains (-1000 Da) as the nexus for crosslinking, it is possible that nanoscale star-like moieties contribute to the nanostructure (FIG. 1). The “arms” of the star are divinyl PDMS chains (M^{Vi}MM^{Vi}, 28 kDa) that can be modeled as a random coils with root mean square end to end distances of˜8 nm. Clusters of stars with higher crosslink densities would account for the complex nanostructure seen in FIG. 7. While the morphology deserves more detailed study, the range of structural features (FIGS. 5-7) is the likely origin of superior mechanical properties presented in the next section.

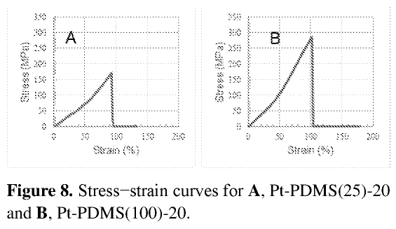

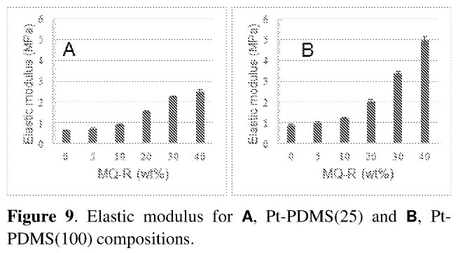

Bulk Characterization. Stress strain measurements. Representative stress-strain curves determined at ambient temperature for coatings with 20% MQ-R resin cured at 25 or 100° C. are presented in FIG. 8. Moduli from the initial slope of stress-strain curves are shown in FIG. 9 and listed in Table 7.

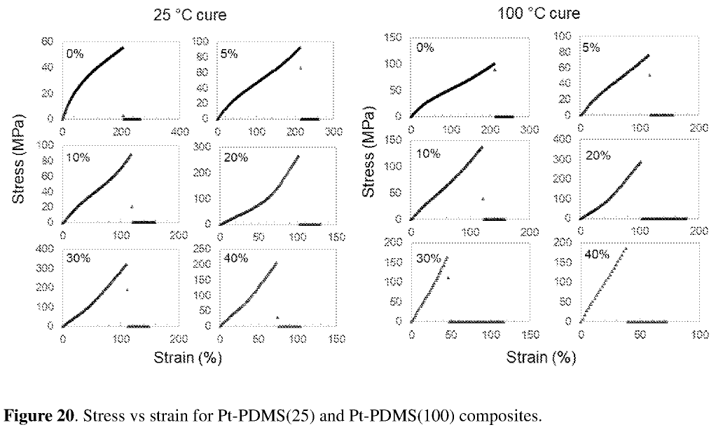

Stress strain curves are characterized by modest strain hardening at ˜50%. Strain hardening is not observed for Pt-PDMS(25)-0, the base elastomer cured at 25° C. (FIG. 20). However, to varying degrees a tendency for strain hardening is observed above 50% for the base elastomer with 100° C. cure and for Pt-PDMS(25) and Pt-PDMS(100) containing MQ-RStrain hardening is attributed to increased interactions of MQ-R with the PDMS matrix. In situ synchrotron radiation X-ray nano-computed tomography (Nano-CT) imaging of the structural evolution occurring during strain of a silicone elastomer comprised of silica nanofiller in a free radically crosslinked silicone matrix showed that the silica nanofiller formed a three dimensional network coupled to the silicone chain network. Nanofiller coupling with the PDMS network was thought to account for increased toughness. A similar mechanism explains strain hardening seen for both Pt-PDMS(25) and Pt-PDMS(100) elastomeric nanocomposites.

For a given composition, the modulus for Pt-PDMS(25) coatings is lower than the modulus of Pt-PDMS(100) analogs (FIG. 9). Up to ˜20 wt % MQ-R the modulus for Pt-PDMS(25) coatings is about 10% less than for Pt-PDMS(100) analogs. The increased modulus for Pt-PDMS(100) reflects the impact of a secondary network from condensation cure. An increase in modulus for Sylgard 184 with increasing cure temperature along with strain hardening was previously reported.

Unexpectedly, the modulus increased to much higher values for Pt-PDMS(100) at 30% and 40% MQ-R. This trend culminates in a modulus for Pt-PDMS(100)-40 that is double that for Pt-PDMS(25)-40. A higher modulus for Pt-PDMS(100) at 30% and 40% MQ-R is attributed to a chemical reaction of MQ-R with matrix Si—H and/or Si—OH that increases crosslink density via the formation of a third network. Additional evidence for this hypothesis comes from dynamic mechanical analysis in the next section.

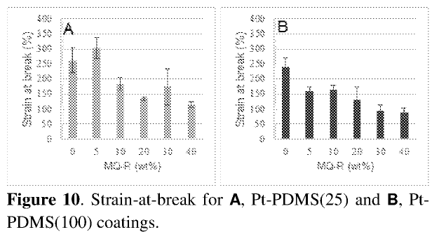

A strain at break of ˜100% is typically found for silicone nanocomposites. For Pt-PDMS compositions with lower MQ-R content a relatively high (>150%) strain at break is found. The high modulus for high MQ-R content is accompanied by a decreased strain at break to˜100% for both Pt-PDMS(25) and Pt-PDMS(100) elastomers (FIG. 10).

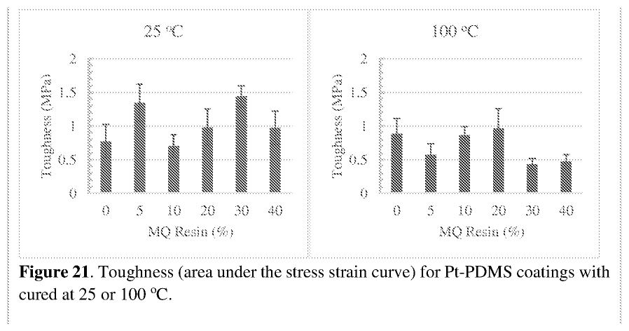

Toughness was determined using the area under the stress strain curves (FIG. 21). Overall, toughness for Pt-PDMS(25) was lower than Pt-PDMS(100). Increased modulus increases the area under the stress-strain curve while decreased strain at break has the opposite effect. These counterbalancing effects preclude systematic trends.

DMA and DSC analysis. Studies aimed at understanding low temperature thermal transitions have been carried out for PDMS, PDMS segmented and block copolymers and PDMS nanocomposites. Rates and/or extents of polydimethylsiloxane crystallization are affected by parameters including crosslink density, molecular weight and the presence of nanoparticles. For example, a prior DMA and DSC study on a PDMS nanocomposite containing 10% silica nanoparticles showed that transitions are sensitive to heating and cooling rates.

For Pt-PDMS coatings reported herein the importance of DMA data rests on the determination of mechanical properties at −10 or −30° C. because these are test temperatures for ice adhesion measurements. DSC was used as a complementary method to identify phase transitions accompanied by thermomechanical changes.

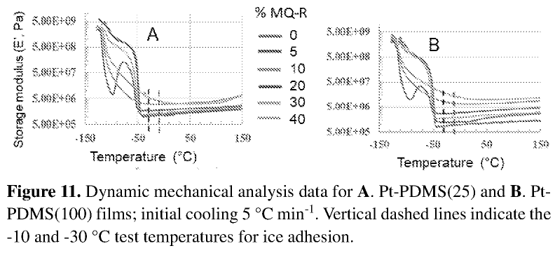

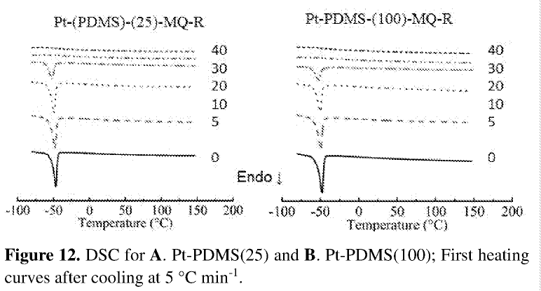

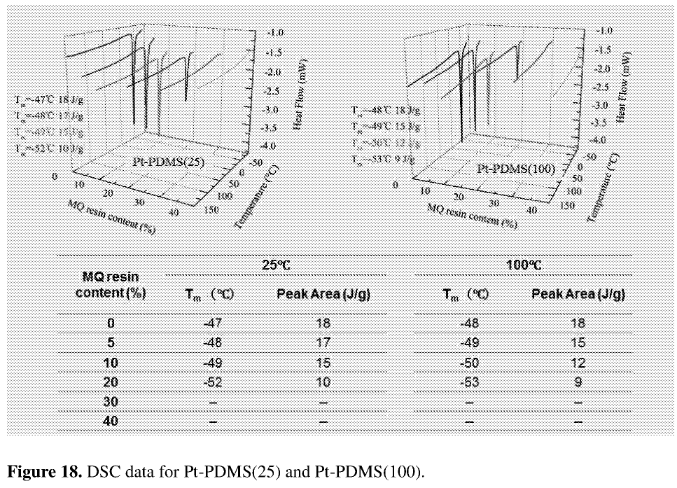

DMA for Pt-PDMS(25) and Pt-PDMS(100) films is shown in FIG. 11. Similar S-shaped curves with inflections in the vicinity of −100° C. are observed for Pt-PDMS(25), Pt-PDMS(25)-5 and Pt-PDMS(25)-10. These changes in slope are assigned to the well-known PDMS T_{g} (α-relaxation), which shifts to about −90° C. for Pt-PDMS(100) analogs. The DMA data for Pt-PDMS(25) and Pt-PDMS(100) are characterized by precipitous decreases in E′ at −50° C. DSC shows that this thermomechanical transition is associated with the melting of a PDMS crystalline phase (FIG. 12). The endotherm peak area shows a decreasing trend from 18 to 10 J/g for Pt-PDMS(25) with 0, 5, 10 and 20% MQ-R (FIG. 18). A similar result is found for analogous Pt-PDMS(100) compositions (18 to 9 J/g). From these results, higher MQ-R content decreases chain mobility required for nucleation and growth of the crystalline phase.

Cold crystallization is evidenced by an E′ peak at −75° C. for Pt-PDMS(25)-20 and Pt-PDMS(100)-20. This thermomechanical transition results in a ×10 decrease in modulus for Pt-PDMS(25)-20 while the decrease for Pt-PDMS(100)-20 is ×5. Cold crystallization occurred after cooling at 5° C. min⁻¹ but not for slow cooling (1° C. min⁻¹). The absence of an exotherm in DSC for crystallization for Pt-PDMS(25)-20 and Pt-PDMS(100)-20 is attributed to differences in PDMS molecular weights and instrument limitations for cooling below about −85° C. (FIG. 12).

Nanocomposites with 30 and 40% MQ-R have a small change in slope for E′ at about−100° C. near the instrumentation limit. An endotherm at −50° C. is absent for Pt-PDMS(25) and Pt-PDMS(100) with 30 and 40% MQ-R. Rather, a rapid decrease in E′ occurs to about −50° C. where E′ levels out. The glass-like state for Pt-PDMS(100) with 30 and 40 wt % MQ-R results in a higher modulus at ice release test temperatures compared to Pt-PDMS(25) analogs (FIG. 11, Table 7). Trends and other data influencing ice adhesion are discussed in the next section.

Ice adhesion measurements. Modes for ice release. Coating thickness was fixed at ˜270 μm as our previous study showed that peak removal force leveled off at this thickness.

By keeping the probe distance at 2 mm, which is a practical minimum, non-shear contributions are minimized and/or approximately constant. Thus, by not changing the probe distance, coating thickness and contact area, the peak removal force for ice at two test temperatures can be examined for correlations with bulk and surface characterization data.

Representative ice release tests at −10 and −30° C. for Pt-PDMS(25)-20 and Pt-PDMS(100)-20 are shown in FIG. 13. A sharp increase in force occurs up to τ_{ice}, the peak removal force in shear (kPa). For ice release “Mode 1” adhesive fracture occurred with no visible ice remnants after tests and immediate return to zero force. About 39% (69 out of 174) ice release tests at −10° C. were Mode 1.

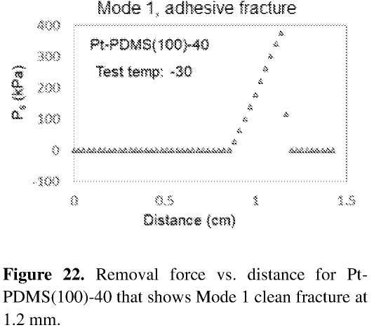

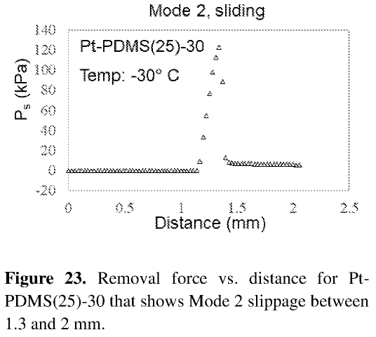

“Mode 2” ice release was characterized by decreases in shear stress at τ_{ice} to low values, but stress did not reach zero for the remainder of the measurement. FIGS. 22-23 provide typical measurements for Mode 2 ice release where ice cylinder sliding occurred.

Mode 2 was common in a previous study of thickness dependence of τ_{ice} for Sylgard 184 but not as common for tests carried out in the present work. About 34% (59 out of 174) tests for ice adhesion resulted in Mode 2 (sliding) release.

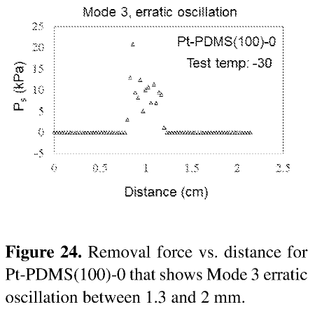

For “Mode 3” ice release shear stress oscillated after τ_{ice}. After one or more oscillations zero force was reached. Mode 3 ice release is illustrated for unfilled Pt-PDMS(100)-0 in FIG. 24. Mode 3 ice release was observed for 27% of tests (47 out of 174).

The area under the force-distance curve corresponds to removal energy. Qualitatively, Mode 2 and Mode 3 ice release involve a higher removal energy compared to Mode 1. The absence of a pattern for the different Modes precludes an explanation and requires further study. Below, data for specific compositional ranges are presented.

Low MQ-R (5, 10, 20 wt %). Whether cured at ambient temperature or 100° C., Pt-PDMS nanocomposites with 5 and 10 wt % MQ-R are noteworthy for having τ_{ice} at or below 20 kPa for tests at −10° C. These compositions have the lowest storage moduli at the −10° C. test temperature: 1.05 and 1.24 mPa, respectively, (Table 3). At −10° C., τ_{ice} follows compositions with higher modulus in accord with Eq. 2. It is important to note that τ_{ice} for Pt-PDMS(25)-5 (17 kPa) and Pt-PDMS(100)-5 (19 kPa) was achieved without employing solvents or addition of oils and did not employ fluorous moieties that are likely PFOA-containing precursors.

An effect of increased MQ-R wt % is seen with an increase in storage modulus at −10° C. from 1.3 MPa for Pt-PDMS(25)-10 to 1.89 MPa for Pt-PDMS(100)-10. Within experimental error the effect of increased modulus does not affect τ_{ice} at −10° C. for Pt-PDMS(25)-10 (21 kPa) compared to Pt-PDMS(25)-5 (19 kPa) (Table 3). For τ_{ice} at −10° C., Pt-PDMS(25)-10 (21 kPa) is about the same as that for Pt-PDMS(100)-10 (22 kPa). Compared to Pt-PDMS(25) and Pt-PDMS(100) with 5 and 10 wt % MQ-R increasing MQ-R to 20 wt % results in an increase in τ_{ice}. At −10° C. τ_{ice} is 36 kPa for Pt-PDMS(25)-20 and 38 kPa for Pt-PDMS(100)-20 which correlates with higher storage moduli (1.71 and 2.76 MPa, respectively).

At the test temperature of −30° C., the storage moduli for Pt-PDMS(25)-5 (1.08 kPa) and Pt-PDMS(100)-5 (1.16 kPa) follow an increase in tensile modulus with increasing cure temperature reported by others. However, τ_{ice} is lower for Pt-PDMS(100)-5 (24 kPa) compared to Pt-PDMS(25)-5 (29 kPa). Similarly, at the −30° C. test temperature Pt-PDMS(100)-10 with a higher modulus (E′ 1.74 MPa) than Pt-PDMS(25)-10 (E′ 1.22 MPa) has a lower τ_{ice} (28 kPa) than Pt-PDMS(25)-10 with τ_{ice} 34 kPa.

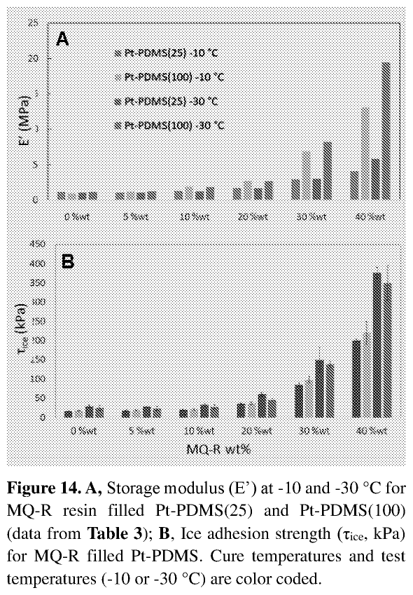

TABLE 3
Storage modulus (E') and ice adhesion strength (τ_{ice}) MQ-R filled PDMS
(data for FIG. 14).

| | Pt-PDMS(25) −10° C. | | Pt-PDMS(100) −10° C. | | Pt-PDMS(25) −30° C. | | Pt-PDMS(100) −30° C. | |
|---|---|---|---|---|---|---|---|---|
| Wt %^{a} | E' (MPa) | τ_{ice} (kPa) | E' (MPa) | τ_{ice} (kPa) | E' (MPa) | τ_{ice} (kPa) | E' (MPa) | τ_{ice} (kPa) |
| 0 | 1.18 | 17 ± 1 | 0.94 | 19 ± 1 | 1.05 | 35 ± 3 | 0.87 | 26 ± 7 |
| 5 | 1.05 | 19 ± 2 | 1.24 | 20 ± 1 | 1.08 | 29 ± 0 | 1.16 | 24 ± 5 |
| 10 | 1.3 | 21 ± 1 | 1.89 | 22 ± 2 | 1.22 | 34 ± 2 | 1.74 | 28 ± 5 |
| 20 | 1.71 | 36 ± 2 | 2.76 | 38 ± 4 | 1.69 | 61 ± 5 | 2.65 | 46 ± 3 |
| 30 | 2.93 | 86 ± 4 | 6.93 | 99 ± 8 | 3.08 | 150 ± 33 | 8.3 | 138 ± 9 |
| 40 | 4.15 | 201 ± 4 | 13.1 | 221 ± 29 | 5.85 | 377 ± 15 | 18.4 | 350 ± 46 |

^{a}Weight percent MQ-R.
^{b}τ_{ice} are average values that include all Modes of ice adhesion.

At −30° C. the storage modulus for Pt-PDMS(100)-20 (2.65 kPa) is substantially higher than Pt-PDMS(25)-20 (1.69 kPa). Again, however, at −30° C., τ_{ice} is clearly lower for Pt-PDMS(100)-20 (46 kPa) compared to Pt-PDMS(25)-20 (61 kPa).

High MQ-R (30, 40 wt %). At 30 and 40% MQ-R storage modulus (E′) increases dramatically (FIG. 14A). The storage modulus at −10° C. for Pt-PDMS(25)-30 (2.93 MPa) increases to 6.93 MPa for Pt-PDMS(100)-30. Thus E′ for Pt-PDMS(100)-30 is over double that for Pt-PDMS(25)-30 and six times that for Pt-PDMS(100)-20.

The storage moduli for 40 wt % MQ-R are remarkably high ranging from 4.15 MPa at −10° C. for Pt-PDMS(25)-40 to 18.4 MPa for Pt-PDMS(100)-40. The amplification is attributed to a chemical reaction of MQ-R with the PDMS matrix and a change in morphology to a glass like solid without a detectable PDMS Tₘ (FIG. 12).

### DISCUSSION

Ice adhesion strength for Pt-PDMS MQ-R coatings. FIG. 14A summarizes storage modulus E′ at −10 and −30° C. for MQ-R filled Pt-PDMS(25) and Pt-PDMS(100) while FIG. 14B shows ice adhesion strength (τ_{ice}). Table 3 lists storage modulus (E′) and Tice for FIG. 14. A primary correlation of τ_{ice} with increasing storage modulus E′ is apparent for the test temperature of −10° C. That is, τ_{ice} is systematically higher at −10° C. for Pt-PDMS(100) compared to Pt-PDMS(25). This is apparent because orange bars are higher that grey bars (FIG. 14B).

At −30° C. the elastic modulus is also higher for Pt-PDMS(100) compared to Pt-PDMS(25) (Table 3). Surprisingly, however, tests at −30° C. show a systematic trend of lower τ_{ice} for cure at 100° C. compared to −10° C. That is, blue bars are higher than orange bars (FIG. 14B).

Theory and Ice adhesion. Kendall developed a theory for removing a rigid object from an elastomeric substrate. When adapted for adhesion of ice to an elastomer, Eq 4 is derived that correlates the force required to remove a rigid cylinder (τ_{ice}) with work of adhesion (wₐ), modulus (K), thickness (t), and area of contact (a). A similar relationship was derived by Ghasemi.

$${τ}_{i c e} ∝ π {{a}^{2} ( \frac{2 {w}_{a} K}{t} )}^{1 / 2} \qquad Eq 4$$

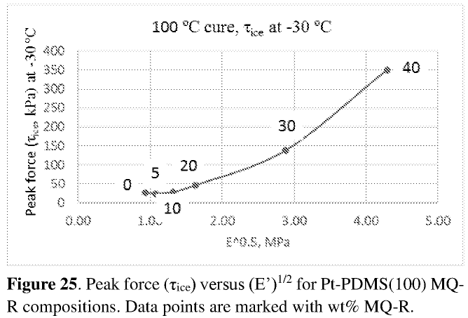

This relationship gave a good fit to the thickness dependence of ice adhesion for a model elastomer (Sylgard 184) over a coating range of 20-300 μm. The prediction that τ_{ice} is proportional to modulus is borne out by increasing τ_{ice} at −10° C. with increasing MQ-R wt % (FIG. 14, Table 3). Equation 4 predicts a correlation of (E′)^{1/2} with τ_{ice}. but attempts to correlate (E′)^{1/2} with τ_{ice} gave nonlinear relationships. An example is shown in FIG. 25.

This finding supports the notion that MQ-R is a reactive filler that increases the modulus by forming a third network depending on temperature and time.

A surprise was lower τ_{ice} at −30° C. for Pt-PDMS-(100) MQ-R compositions compared with their Pt-PDMS(25) counterparts that have lower storage moduli (FIG. 14). There is limited precedence for ice adhesion studies on silicones at −30° C. or lower temperatures.

Prior work on poly(PDMS-b-polycarbonate) included adding silicone oil for enhanced ice release. The temperature dependence of ice adhesion (−5 to −20° C.) was reported for a copolymer containing 35 wt % PDMS (dₚ ˜20). Interestingly, a maximum in ice adhesion was found at −10° C., with much lower adhesion at −20° C. Oil addition resulted in a tenfold reduction of adhesion along with a flattening of temperature dependence.

A model to explain lower Tice for Pt-PDMS(100) at −30° C. begins with considering the theory of wetting behavior for heterogeneous surfaces developed by Pease (Pease, D. M., J. Phys. Chem. 1945, 49, 107-110.) and later by Johnson and Dettre (Johnson, R. E., Jr.; Dettre, R. H., J. Phys. Chem. 1964, 68 (7), 1744-1750). These pioneers showed that a small area fraction of polar moieties had little effect on θ_{A} but a strong effect on θ_{R} due to water-pinning by hydrogen bonding. This model is adapted herein with consideration of studies of supercooled water and/or mixtures.

Others have reduced ice adhesion by creating hydrophilic “anti-freeze” surfaces. With a test temperature of −15° C., others reduced τ_{ice} from −320 kPa for Sylgard 184 to −120 kPa by adding a minor amount of PDMS-PEG copolymer. This finding was attributed to interfacial lubrication by nonfrozen water. Grafting polyacrylic acid to a silicon wafer and crosslinking with water-soluble polyethylene glycol diacrylate gave a film that absorbed water and decreased τ_{ice} to˜55 kPa at test temperatures of −15 to −22° C. At lower temperatures τ_{ice} rapidly increased to more than 1000 kPa as supercooled water froze and pinned ice. The hydrophilic polymer film thus decreased the freezing point of water to about −20° C. An even lower freezing point depression was obtained by the synthesis of polyurethane nanoparticles having a hydrophilic corona and a polyurethane core. An aqueous dispersion was used for coating and subsequent curing. For optimum compositions the freezing point of water was reduced to about −50° C. Ice adhesion strength was maintained at −27 kPa from −15 to −50° C. Others have also shown a freezing point depression for surfaces functionalized with hydrophilic polymers. From these studies the freezing point depression of surface water depends on surface chemistry and morphology.

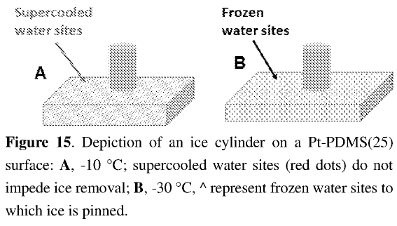

According to the analysis of θ_{R} described above, Pt-PDMS(25) has a higher density of interfacial water than Pt-PDMS(100) analogs as Wₐ₋₂₅/Wₐ₋₁₀₀ ranges from 1.5 to 2. Lower adhesion of ice for Pt-PDMS(100) MQ-R compositions at −30° is then explained by the hypothesis that interfacial water is frozen at −30° C. but liquid/supercooled at −10° C. This is illustrated in FIG. 15 that depicts an ice cylinder on a Pt-PDMS surface. In FIG. 15A, supercooled interfacial water sites at −10° C. (red dots) do not impede ice removal, while FIG. 15B depicts frozen interfacial water represented by ∧ that pin ice at −30° C. It follows from this hypothesis that Pt-PDMS(100) coatings have high receding contact angles and a relatively sparse distribution of frozen interfacial water at −30° C. compared to Pt-PDMS(25) analogs. As a consequence of a relatively low interfacial density of frozen “pinning sites”, τ_{ice}is less for Pt-PDMS(100) than that for Pt-PDMS(25) analogs at −30° C. despite the higher modulus for Pt-PDMS(100) coatings.

Following the hypothesis that water pinning sites are in a liquid/supercooled state at −10° C., the removal of ice is not impeded and modulus controls ice release (Eq 2). That is, Pt-PDMS(100) coatings have a higher modulus than Pt-PDMS(25) analogs resulting in τ_{ice} at −10° C. for Pt-PDMS(25) coatings being lower than Pt-PDMS(100).

In contrast to hydrophilic “anti-freeze” surfaces described above, the surface concentration of hydrophilic pinning sites defined by θ_{R} is low as PDMS surfaces are otherwise hydrophobic as defined by θ_{A}. Considering the theory of Johnson & Dettre, a solid with a receding contact angle of ˜40° would have a surface fraction of hydrophilic sites on the order of 0.05 or 5%. Thus, the effect of pinning ice by frozen interfacial water is moderate. At −30° C. τ_{ice} is about 15% less for Pt-PDMS(100) compared to Pt-PDMS(25).

### CONCLUSION

Icephobicity is characterized by low adhesion strength for ice but tests and standards are not yet in place. Furthermore, icephobicity will depend on the form of ice such as frost or glaze. For the stress test used herein a value of τ_{ice}<30 kPa at −30° C. may be reasonably taken as a threshold for icephobicity. This threshold was reached for an “antifreeze” coating described as “self-lubricating”. The peak removal force (27 kPa) was retained until the freezing point was reached (˜−50° C.). A similar peak removal force range is found for PDMS blended with oils such as “slippage” coatings prepared by blending 40 wt % silicone oil with a commercial silicone elastomer.

Given the criterion of τ_{ice}, <30 kPa at −30° C., Pt-PDMS(25)-5 and Pt-PDMS(100)-5 qualify for the icephobic designation (Table 3). Interestingly, Pt-PDMS(100)-10 also meets this criterion (τ_{ice}=28 kPa) but Pt-PDMS(25)-10 fails (τ_{ice}=34 kPa). At 20 wt % MQ-R and above, τ_{ice} increases above 30 kPa at −30° C. even for Pt-PDMS(100) compositions. Decreased interfacial water density is unable to overcome the effect of increased modulus.

The impact of MQ-R in increasing the modulus of Pt-PDMS is surprising and unexpected. Provided herein is a comparison of Pt-PDMS with 30 and 40 wt % MQ-R with a report of mechanical properties for six commercial platinum cured systems. These systems are meant for injection molding applications with cure carried out at elevated temperatures (−200° C.) for less than one minute. Dynamic mechanical analysis (frequency sweep) showed that E′ at ambient temperature was between 2 and 3×10⁶ MPa for all six products. Pt-PDMS(100)-30 and Pt-PDMS(100)-40 have ambient temperature E′ in the same range, namely 2-4×10⁶ MPa (FIG. 9A).

Equation 4 predicts a correlation of (E′)^{1/2} with τ_{ice}. As discussed above, attempts to correlate (E′)^{1/2} with τ_{ice} gave nonlinear relationship (FIG. 25). This finding supports the inventors'belief that MQ-R is a reactive filler and forms a third network depending on temperature and time.

Leaching, contact angles and ice adhesion. Dynamic contact angles were obtained by the Wilhelmy plate method that involves coating a coverslip and immersion in water.

Details are in the Experimental section. The characterization focused on Pt-PDMS(25) and Pt-PDMS(100) MQ-R coatings (1) to obtain contact angles, especially the receding contact angle (θ_{R}) which is connected to adhesion of water to silicone coatings and (2) to determine whether or not leaching (oils, surfactants, processing materials) affected the adhesion of ice.

Systematic changes in work of adhesion and the connection to adhesion of ice have been presented and discussed in the main paper. In the section below, evidence for leaching is presented. In summary, we were not able to connect changes in leaching into water during Wilhelmy plate measurements to ice adhesion.

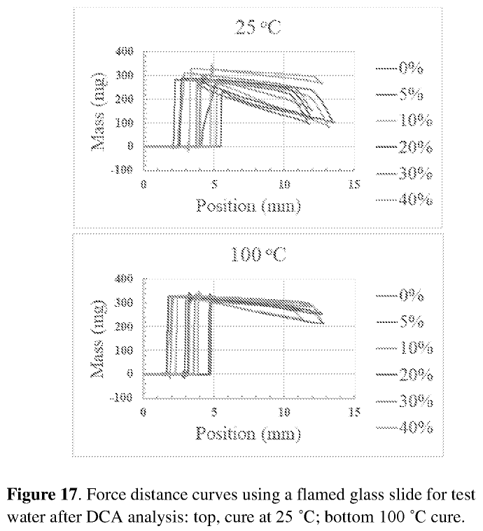

Table 4 lists DCA data taken for repeated runs on Pt-PDMS(25) and Pt-PDMS(100) MQ-R coatings. Receding contact angles for Pt-PDMS(100) coatings are reasonably stable while variations are observed for coatings prepared at ambient temperature. FIG. 17 shows Wilhelmy plate force distance curves (fdc's) using a flamed glass slide for testing water after DCA analysis.{Uilk, 2003 #8115;Wang, 2017 #7740;Wang, 2017 #7740} If oils or other contaminants such as processing aids leach and rise to the water/air interface the surface tension of water decreases. Evidence for leaching from Pt-PDMS(25) coatings is reflected in changes for θ_{A} and θ_{R} from first to third DCA runs for 0 to 30 wt % MQ-R filled (Table 4). For example, for the first DCA cycle for Pt-PDMS(25)-20 is 131°, which decreases to 1190 for cycle 3. This decrease of about 100 is typical for 0 to 30 wt % MQ-R coatings and is apparent from inspection of force distance curves in FIG. 17. Interestingly, for 25° C. cure, only Pt-PDMS(25)-40 is free of water contamination due to leached species which is attributed to an increasingly complex path for diffusing species with increasing MQ-R content.

Minimal water contamination is found for Pt-PDMS(100) coatings. Condensation cure at 100° C. forms a second network that may provide a contorted pathway for leaching or low molar mass species may be incorporated in the network. In addition, volatile species are simply removed.

TABLE 4
Wilhelmy plate DCA advancing and receding CAs for
MQ-R filled Pt-PDMS(25) and Pt-PDMS(100).^{a}

| | | Pt-PDMS(25) | | | | Pt-PDMS(100) | | | |
|---|---|---|---|---|---|---|---|---|---|
| MQ-R | | Run 1 | | Run 2 | | Run 1 | | Run 2 | |
| wt % | Cycle | θ_{A} | θ_{R} | θ_{A} | θ_{R} | θ_{A} | θ_{R} | θ_{A} | θ_{R} |
| 0 | Cycle 1 | 124 | 60 | 124 | 61 | 117 | 89 | 115 | 84 |
| | Cycle 2 | 117 | 68 | 117 | 69 | 114 | 86 | 112 | 82 |
| | Cycle 3 | 116 | 69 | 117 | 68 | 113 | 94 | 111 | 82 |
| 5 | Cycle 1 | 136 | 52 | 136 | 40 | 115 | 91 | 116 | 92 |
| | Cycle 2 | 122 | 48 | 126 | 45 | 115 | 98 | 115 | 101 |
| | Cycle 3 | 121 | 49 | 122 | 46 | 108 | 101 | 108 | 100 |
| 10 | Cycle 1 | 133 | 62 | 131 | 61 | 116 | 93 | 116 | 92 |
| | Cycle 2 | 128 | 60 | 129 | 61 | 116 | 96 | 116 | 91 |
| | Cycle 3 | 124 | 60 | 125 | 61 | 111 | 97 | 116 | 99 |
| 20 | Cycle 1 | 131 | 37 | 135 | 32 | 118 | 93 | 116 | 94 |
| | Cycle 2 | 122 | 48 | 138 | 44 | 116 | 95 | 116 | 94 |
| | Cycle 3 | 119 | 47 | 120 | 43 | 114 | 99 | 117 | 101 |
| 30 | Cycle 1 | 135 | 24 | 137 | 22 | 119 | 92 | 118 | 90 |
| | Cycle 2 | 137 | 37 | 137 | 34 | 117 | 91 | 119 | 92 |
| | Cycle 3 | 123 | 36 | 122 | 36 | 117 | 92 | 118 | 91 |
| 40 | Cycle 1 | 127 | 44 | 126 | 42 | 119 | 90 | 119 | 89 |
| | Cycle 2 | 125 | 42 | 125 | 41 | 120 | 89 | 118 | 89 |
| | Cycle 3 | 125 | 43 | 126 | 42 | 119 | 89 | 117 | 90 |

^{a}Run 1 and Run 2 refer to different coated coverslips. Multiple runs were carried

TABLE 5
Wilhelmy plate DCA θ_{A}, θ_{R} and θ_{Δ} for MQ-R
filled P-PDMS(25) and P-PDMS(100).^{a}

| MQ | | | | | | | |
|---|---|---|---|---|---|---|---|
| resin | | | | | | | |
| content | | Pt-PDMS(25) | | | Pt-PDMS(100) | | |
| (wt %) | Cycle | θ_{A} | θ_{R} | θ_{Δ} | θ_{adv} | θ_{rec} | θ_{Δ} |
| 0 | Cycle 1 | 124 | 60 | 64 | 117 | 89 | 28 |
| | Cycle 2 | 117 | 68 | 49 | 114 | 86 | 28 |
| | Cycle 3 | 116 | 69 | 47 | 113 | 94 | 19 |
| 5 | Cycle 1 | 136 | 52 | 84 | 115 | 91 | 24 |
| | Cycle 2 | 122 | 48 | 74 | 115 | 98 | 17 |
| | Cycle 3 | 121 | 49 | 72 | 108 | 101 | 7 |
| 10 | Cycle 1 | 133 | 62 | 71 | 116 | 93 | 23 |
| | Cycle 2 | 128 | 60 | 68 | 116 | 96 | 20 |
| | Cycle 3 | 124 | 60 | 64 | 111 | 97 | 14 |
| 20 | Cycle 1 | 131 | 37 | 94 | 118 | 93 | 25 |
| | Cycle 2 | 122 | 48 | 74 | 116 | 95 | 21 |
| | Cycle 3 | 119 | 47 | 72 | 114 | 99 | 15 |
| 30 | Cycle 1 | 135 | 24 | 111 | 119 | 92 | 27 |
| | Cycle 2 | 137 | 37 | 100 | 117 | 91 | 26 |
| | Cycle 3 | 123 | 36 | 87 | 117 | 92 | 25 |
| 40 | Cycle 1 | 127 | 44 | 83 | 119 | 90 | 29 |
| | Cycle 2 | 125 | 42 | 83 | 120 | 89 | 31 |
| | Cycle 3 | 125 | 43 | 82 | 119 | 89 | 30 |

^{a}Contact angle hysteresis = θ_{Δ} = θ_{A} − θ_{R}

TABLE 6
Receding contact angles for Pt-PDMS coatings and the ratio of work of adhesion for
water for samples cured at 25 or 100° C. (Eq. 3).

| MQ resin content | θ_{R-25} | 1 + c | | 1 + | Wₐ₋₂₅/ |
|---|---|---|---|---|---|
| (%) | (°) | osθ_{R-25} | θ_{R-100} (°) | cosθ_{R-100} | Wₐ₋₁₀₀ |
| 0 | 60 | 1.50 | 89 | 1.02 | 1.47 |
| 5 | 52 | 1.62 | 91 | 0.98 | 1.64 |
| 10 | 62 | 1.47 | 93 | 0.95 | 1.55 |
| 20 | 37 | 1.80 | 93 | 0.95 | 1.90 |
| 30 | 24 | 1.91 | 92 | 0.97 | 1.98 |
| 40 | 44 | 1.72 | 90 | 1.00 | 1.72 |

TABLE 7
Storage modulus E′ (MPa) for Pt-PDMS(25) and
Pt-PDMS(100) at 10 and −30° C.

| | Storage Modulus E′ (MPa) | | | |
|---|---|---|---|---|
| MQ resin | 25° C. cure | | 100° C. cure | |
| content (%) | −10° C. | −30° C. | −10° C. | −30° C. |
| 0 | 1.18 | 1.05 | 0.94 | 0.87 |
| 5 | 1.05 | 1.08 | 1.24 | 1.16 |
| 10 | 1.3 | 1.22 | 1.89 | 1.74 |
| 20 | 1.71 | 1.69 | 2.76 | 2.65 |
| 30 | 2.93 | 3.08 | 6.93 | 8.3 |
| 40 | 4.15 | 5.85 | 13.1 | 18.4 |

The entire contents of each reference mentioned herein are hereby incorporated by reference for all purposes.

The entire contents of Safety Data Sheet for Product name SYL-OFF™ 7210 Release Modifier, published by The Dow Chemical Company, Issue Date 10/31/2018, 17 pp, are hereby incorporated by reference for all purposes.

1. A composition, comprising a polymerization product of a reactant composition, the reactant composition comprising:
(a) vinyldimethylsiloxy-terminated polydimethylsiloxane, as monomer (M^{vi}DM^{vi});
(b) 45-55% poly(methylhydro-co-dimethylsiloxane), α, Ω-trimethylsiloxy terminated, as crosslinker (MDHDM);
(c) platinum-divinyltetramethyl-disiloxane complex, as catalyst;
(d) 2,4,6,8-tetramethyl-2,4,6,8-tetravinylcyclotetrasiloxane, as inhibitor; and
(e) a filler-like resin composition comprising one or more of dimethylvinylated silica, trimethylated silica, and tetra(trimethylsiloxy)silane, as active ingredient, and one or more of xylene, ethylbenzene and toluene (MQ-R resin).

2. The composition of claim 1, wherein the vinyldimethylsiloxy-terminated polydimethylsiloxane (M^{vi}DM^{vi}) has a molecular weight of about 28 kDa.

3. The composition of claim 1, wherein the vinyldimethylsiloxy-terminated polydimethylsiloxane (M^{vi}DM^{vi}) is present in an amount of about 40-94 wt. % based on the weight of the reactant composition.

4. The composition of claim 1, wherein the 45-55% poly(methylhydro-co-dimethylsiloxane), α, Ω-trimethylsiloxy terminated, has a molecular weight of about 900-1200 Da.

5. The composition of claim 1, wherein the 45-55% poly(methylhydro-co-dimethylsiloxane), α, Ω-trimethylsiloxy terminated, is present in an amount of about 1-15 wt. % based on the weight of the reactant composition.

6. The composition of claim 1, wherein the platinum-divinyltetramethyl-disiloxane complex is present in an amount of about 0.01 wt. % or less (measured as Pt); based on the weight of the reactant composition.

7. The composition of claim 1, wherein the 2,4,6,8-tetramethyl-2,4,6,8-tetravinylcyclotetrasiloxane is present in amount of about 0.2-1 wt. %, based on the weight of the reactant composition.

8. The composition of claim 1, wherein the active ingredient of the filler-like resin composition (MQ-R resin) is present in an amount of about 5-50 wt. %, based on the weight of the reactant composition.

9. The composition of claim 1, wherein the reactant composition further comprises hexane as solvent.

10. The composition of claim 1, wherein the polymerization product is a product of polymerization at a temperature of about 25 to 160° C.

11. The composition of claim 1, having a storage modulus (E′) of about 1-15 MPa at −10° C.

12. (canceled)

13. The composition of claim 1, wherein the reactant composition comprises:
(a) 40-94 wt. % vinyldimethylsiloxy-terminated polydimethylsiloxane, as monomer (M^{vi}DM^{vi});
(b) 1-15 wt. % 45-55% poly(methylhydro-co-dimethylsiloxane), α, Ω-trimethylsiloxy terminated, as crosslinker (MD^{H}DM);
(c) 0.001-0.005 wt. % (measured as Pt) platinum-divinyltetramethyl-disiloxane complex, as catalyst;
(d) 0.2-1 wt. % 2,4,6,8-tetramethyl-2,4,6,8-tetravinylcyclotetrasiloxane, as inhibitor; and
(e) 5-50 wt. % a filler-like resin composition comprising one or more of dimethylvinylated silica, trimethylated silica, and tetra(trimethylsiloxy)silane, as active ingredient, and one or more of xylene, ethylbenzene and toluene (MQ-R resin).

14. A coating, comprising the composition of claim 1.

15. The coating of claim 14, having a thickness of about 1-1000 μm.

16. The coating of claim 14, having an ice adhesion strength (τ_{ice}) of about 15-40 kPa at −10° C.

17. The coating of claim 14, having an ice adhesion strength (τ_{ice}) of about 20-60 kPa at −30° C.

18. An article, comprising the coating of claim 14 on a surface thereof.

19. The article of claim 18, selected from the group consisting of an airfoil, wing, propeller, hull, superstructure, railing, intake, hatch, keel, rudder, deck, antenna, medical device, kitchen device, counter, pipe, wind turbine, wind turbine blade, aircraft, ship, rotor blade, transmission tower, transmission line, cable, cooling coil, refrigerator, freezer, wire, tape, adhesive tape, wrap, solar panel, window, wall, floor, siding, roofing, shingle, tower, train, train undercarriage, automobile, cowling, cover, evaporator, condenser, radiator, metal, plastic, or combination thereof, comprising any of the coatings or compositions on a surface thereon.

20. The article of claim 18, or any preceding, further comprising,
between the coating and the surface, one or more intervening layer, primer, adhesive, tape, other coating, or a combination thereof.

21. A method, comprising contacting:
(a) vinyldimethylsiloxy-terminated polydimethylsiloxane, as monomer (M^{vi}DM^{vi});
(b) 45-55% poly(methylhydro-co-dimethylsiloxane), α, Ω-trimethylsiloxy terminated, as crosslinker (MDHDM);
(c) platinum-divinyltetramethyl-disiloxane complex, as catalyst;
(d) 2,4,6,8-tetramethyl-2,4,6,8-tetravinylcyclotetrasiloxane, as inhibitor;
and
(e) a filler-like resin composition comprising one or more of dimethylvinylated silica, trimethylated silica, and tetra(trimethylsiloxy)silane, as active ingredient, and one or more of xylene, ethylbenzene and toluene (MQ-R resin),
to produce a reactant composition;
and polymerizing, to produce a polymerization product.

22-40. (canceled)
